(19) United States
(12) Patent Application Publication
(10) Pub. No.: US 2014/0297641 A1
(43) Pub. Date: Oct. 2, 2014

(54) DISCUSSION SUPPORT METHOD, INFORMATION PROCESSING APPARATUS, AND STORAGE MEDIUM

(71) Applicant: FUJITSU LIMITED, Kawasaki-shi (JP)

(72) Inventors: Hidehiko MAYUMI, Kawasaki (JP); Toshio Tanaka, Yokohama (JP); Takeaki Kobayashi, Yokohama (JP); Takehiro Nabae, Chigasaki (JP); Kenji Sakata, Shinagawa (JP)

(73) Assignee: FUJITSU LIMITED, Kawasaki-shi (JP)

(21) Appl. No.: 14/189,079

(22) Filed: Feb. 25, 2014

(30) Foreign Application Priority Data
Mar. 27, 2013 (JP) 2013-067394

(51) Int. Cl. H04L 29/06

(52) U.S. Cl. CPC H04L 65/403
USPC 707/737; 707/748

(57) ABSTRACT

A storage medium storing a discussion support program that causes a computer to execute a process, the process includes collecting opinion data obtained from each information terminal and a group characteristic corresponding to the opinion data collected in each group including a plurality of information terminals set in advance, and calculating a point of a participant related to the information terminal based on representative opinion data chosen from the opinion data collected in each group and the group characteristic corresponding to the group to which the information terminal having transmitted the representative opinion data belongs.

### CROSS-REFERENCE TO RELATED APPLICATION

This application is based upon and claims the benefit of priority of the prior Japanese Patent Application No. 2013-067394, filed on Mar. 27, 2013, the entire contents of which are incorporated herein by reference.

### FIELD

The embodiments discussed herein are related to a discussion support method, an information processing apparatus, and a storage medium storing a program for discussion support.

### BACKGROUND

An attempt is being made to offer education by causing each individual to possess an information terminal and using the possessed information terminal. Examples of a technique for the education using information terminals include a discussion support system. The discussion support system provides a system in which information terminals are used to collect the respective opinions of participants in a discussion and move the discussion forward while the collected opinions are displayed on a screen. Examples of a technique for the above-described discussion include a group discussion technique by which students, who are examples of the discussion participants, are divided into a plurality of groups and have discussions in the respective groups.

One goal of the above-described discussion support system is to grasp discussion skills. For example, in the discussion support system, the discussion skills of each participant are desired to be grasped by observing how the opinions of the participants change through the discussion or how all the opinions become united.

As disclosed in, for example, Japanese Laid-open Patent Publication No. 2004-185614 or Japanese Laid-open Patent Publication No. 2002-140441, there is a technique to perform management by giving points, depending on how much the participants have contributed to uniting the opinions in a discussion on an electronic bulletin board, or a technique to calculate differences in the opinions of participants in a group.

### SUMMARY

According to an aspect of the embodiment, a storage medium storing a discussion support program that causes a computer to execute a process, the process includes collecting opinion data obtained from each information terminal and a group characteristic corresponding to the opinion data collected in each group including a plurality of information terminals set in advance, and calculating a point of a participant related to the information terminal based on representative opinion data chosen from the opinion data collected in each group and the group characteristic corresponding to the group to which the information terminal having transmitted the representative opinion data belongs.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining a form of a discussion using information terminals;

FIG. 2 is a diagram illustrating an example of a general configuration of a discussion support system;

FIG. 3 is a diagram illustrating an example of a hardware configuration of a discussion support server;

FIG. 4 is a flowchart illustrating an example of a process of the discussion support server;

FIG. 5 is a flowchart illustrating an example of a point display process;

FIG. 6 is a diagram illustrating an example of a screen on which a subject is displayed on the information terminal;

FIG. 7 is a diagram illustrating an example of a screen for sharing opinions on the information terminals;

FIGS. 8A to 8C are tables illustrating examples of data used in discussion support;

FIG. 9 is a flowchart illustrating an example of a point calculating process according to Embodiment 1;

FIGS. 10A to 10C are tables illustrating examples of various kinds of data according to Embodiment 1;

FIG. 11 is a flowchart illustrating an example of a point calculating process according to Embodiment 2;

FIGS. 12A and 12B are tables illustrating examples of various kinds of opinion characteristic databases (DBs);

FIGS. 13A and 13B are tables illustrating examples of point DBs according to Embodiment 2;

FIG. 14 is a flowchart illustrating an example of a point calculating process according to Embodiment 3;

FIGS. 15A and 15B are tables of examples of various kinds of data according to Embodiment 3; and

FIG. 16 illustrates an example of a growth graph generated by a display unit.

### DESCRIPTION OF EMBODIMENTS

Embodiments are described in detail below with reference to the accompanying drawings.

[Regarding Discussion Using Information Terminals]

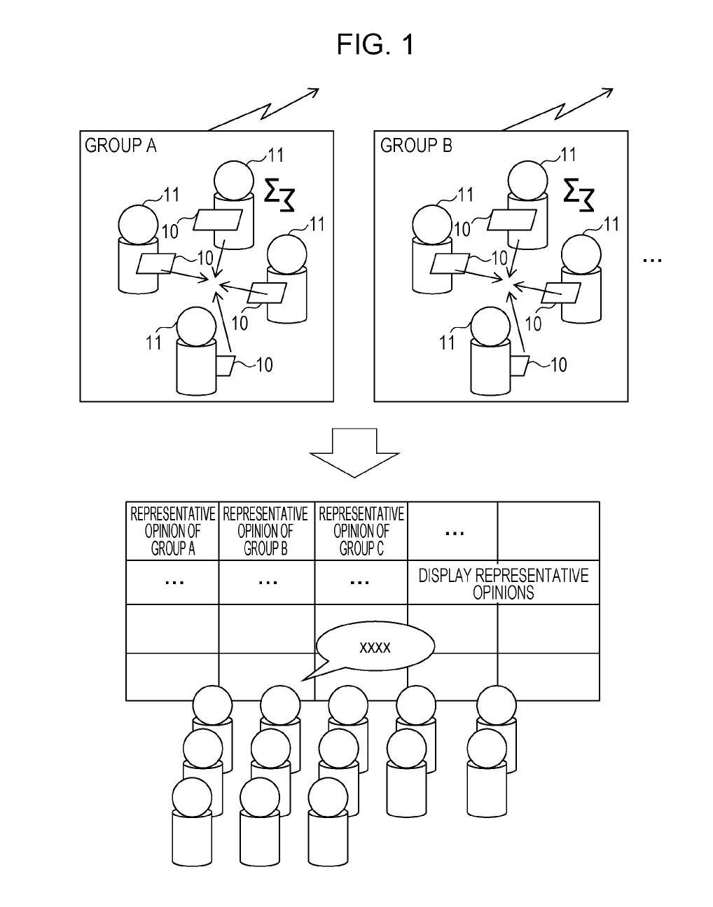

FIG. 1 is a diagram for explaining a form of a discussion using information terminals. FIG. 1 illustrates an example of a group discussion using information terminals 10. In the group discussion using the information terminals 10, the information terminal 10 is distributed to each of participants 11 involved in the discussion, such as students as described below, and the participants 11 input their opinions to the information terminals 10 that the participants 11 possess individually. The input opinions are shared in the group.

In each group, the shared opinions of the participants 11 are discussed and a representative opinion of the group is decided. For example, the discussion in each group, which is each of groups A and B in the example of FIG. 1, may be conducted orally or through chat using the information terminals 10 but is not limited hereto.

When the representative opinion of the group is decided, the representative opinion is transmitted from the information terminal 10 of a group leader to a server or the like. The server or the like on the discussion support side causes a display device to display the representative opinion of each group. The discussion may be further conducted by all the groups after the representative opinion of each group has been displayed on the display device.

A general configuration example of the discussion support system and the like are now described specifically. While the embodiments below describe a case in which students of one class are divided into a plurality of groups and conduct group discussions for example, the form of use of the discussion support system is not limited hereto.

[General Configuration Example of Discussion Support System]

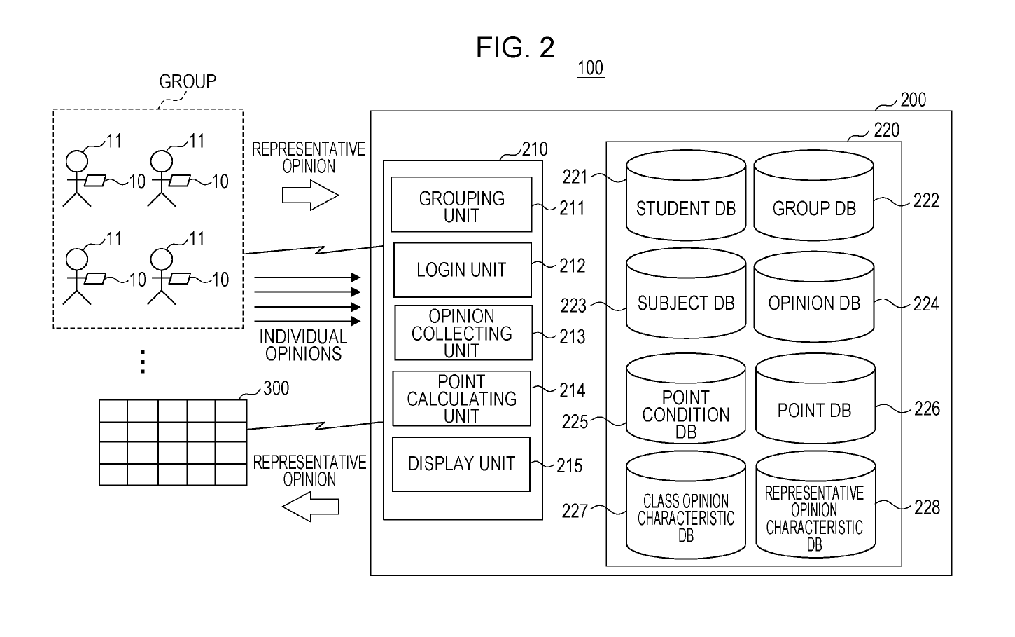

FIG. 2 is a diagram illustrating an example of a general configuration of a discussion support system 100. The discussion support system 100 illustrated in FIG. 2 includes one or more of the above-described information terminals 10, a discussion support server 200 as an example of an information processing apparatus, and a display device 300. The one or more information terminals 10, the discussion support server 200, and the display device 300 are coupled via a communication network, such as the Internet or a local area network (LAN), so as to transmit and receive data. The communication network may be radio communication or wire communication, or may include both of the radio communication and the wire communication.

The discussion support server 200 includes a discussion support unit 210 and a storage unit 220. The discussion support unit 210 includes a grouping unit 211, a login unit 212, an opinion collecting unit 213, a point calculating unit 214, and a display unit 215. The storage unit 220 includes a student database (DB) 221, a group DB 222, a subject DB 223, an opinion DB 224, a point condition DB 225, a point DB 226, a class opinion characteristic DB 227, and a representative opinion characteristic DB 228.

The information terminal 10 is a terminal that each of the students (participants) 10 involved in the discussion possesses. For example, an application or the like is installed in the information terminal 10 so as to conduct a group discussion according to the present embodiment.

The information that the students 11 have input to the information terminals 10 is transmitted to the discussion support server 200 as “opinions”. For example, the opinions include text data input to the information terminals 10 and information indicating choices that reflect the opinions of the students 11 who use the information terminals 10 but are not limited hereto.

The information terminal 10 is, for example, a notebook-type personal computer (PC), a tablet terminal, a smartphone, or the like, but is not limited hereto. The information terminal 10 may include functions of a terminal that a teacher uses, which is referred to as a teacher terminal, instead of including functions of a terminal that a student uses, which is referred to as a student terminal. For example, the information terminal 10 may include functions of a leader terminal that transmits the representative opinion of each group after discussion to the discussion support server 200.

In the discussion support server 200, the discussion support unit 210 relates information that identifies the information terminals 10 and information that identifies the students 11 who use the information terminals 10 to each other, and causes the related information to be stored in the storage unit 220.

In the discussion support unit 210, the grouping unit 211 groups the students 11 under preset conditions. The preset conditions are based on the transition in the previous point calculations of each student, the type of an opinion on a given subject, which is indicated by, for example, “AGREE”, “TOLERATE”, or “DISAGREE”, the instructions from a teacher terminal, and the like but are not limited hereto.

On receiving an attempt of the student 11 to log in to the discussion support server 200 using the information terminal 10 of his or her own, the login unit 212 performs login authentication using user information, a password, and the like, which are input. Also, the login unit 212 notifies the information terminal 10 corresponding to the student 11 permitted to log in of a group name.

The opinion collecting unit 213 transmits a given subject to the information terminal 10 and individually receives opinion data from the information terminal 10.

The point calculating unit 214 detects the characteristic of the opinion data of the group, such as the opinion type, from among the opinion data collected from each group, which includes the plurality of information terminals 10 set in advance. The opinion type is, for example, information that indicates whether the student agrees (“AGREE”), tolerates it (“TOLERATE”), or disagrees (“DISAGREE”) as an opinion on the given subject. The “TOLERATE” represents the state in which the student neither agrees nor disagrees.

As the characteristic of the opinion of the group, for example, information that indicates a “group with only the same opinions as the student's opinion”, a “half-and-half group with opinions the same as and different from the student's opinion”, a “group in which the number of opinions different from the student's opinion is larger than the number of opinions the same as the student's opinion”, or the like may be detected. Whether the opinions are the same or not may be determined based on, for example, the opinion types of the students in the group, which are obtained from the above-described information terminals 10 and indicate “AGREE”, “TOLERATE”, or “DISAGREE”, but the determination is not limited hereto.

Based on the group representative opinion data chosen from the opinion data collected in each group and the opinion data of the group, the point calculating unit 214 calculates points for the opinion data of each of the students related to the information terminals 10 included in the group.

The point conditions in the point calculating unit 214 calculating the points and the calculated point results are stored in the storage unit 220. The point calculating unit 214 may calculate points by, for example, assigning weights caused to correspond to the opinion characteristics in the group or the characteristics of the whole class. Also, the point calculating unit 214 may add a bonus point dependent on the increase rate of the student. As a result, the point evaluation may be observed in various respects.

The display unit 215 generates a screen for inputting the opinions on the subject and a screen for sharing the respective opinions on the subject from the students in the group. Also, the display unit 215 generates a screen for displaying the point calculation results, the point transition of each of the students 11, the opinion of each student, the representative opinion obtained from each group, and the like.

The display unit 215 causes the generated screens to be displayed by transmitting the screens to the information terminal that the student uses (the student terminal), to the information terminal that the teacher uses (the teacher terminal), and to the display device 300. In the present embodiment, for example, the contents of the discussion in the group are transmitted to the teacher terminal or the like as points and thus, the discussion skills of each student, which are not revealed by the discussion results such as the representative opinion, may become clear.

The storage unit 220 stores setting information for performing operations that enable the discussion support process according to the present embodiment, the execution progress or results of each operation, and the like. The information stored in the storage unit 220 is not limited to the student DB 221, the group DB 222, the subject DB 223, the opinion DB 224, the point condition DB 225, the point DB 226, the class opinion characteristic DB 227, or the representative opinion characteristic DB 228 described above. Specific examples of the data stored in the storage unit 220 are described below.

Further, the storage unit 220 may read various kinds of information, which are stored, or write information at a given timing when desired. For example, the storage unit 220 is a hard disk, memory, or the like, but is not limited hereto.

The discussion support server 200 is a general-purpose PC, a server, or the like, but is not limited hereto.

The display device 300 is a shared display that all students in the class may see and is placed at a given position in a classroom so as to be viewable from the seats of the students 11. The display device 300 displays various kinds of information obtained from the display unit 215. The display device 300 may be, for example, what is displayed on a screen with a projector or the like, or be a monitor device, display equipment, or the like but is not limited hereto.

[Hardware Configuration Example of the Discussion Support Server 200]

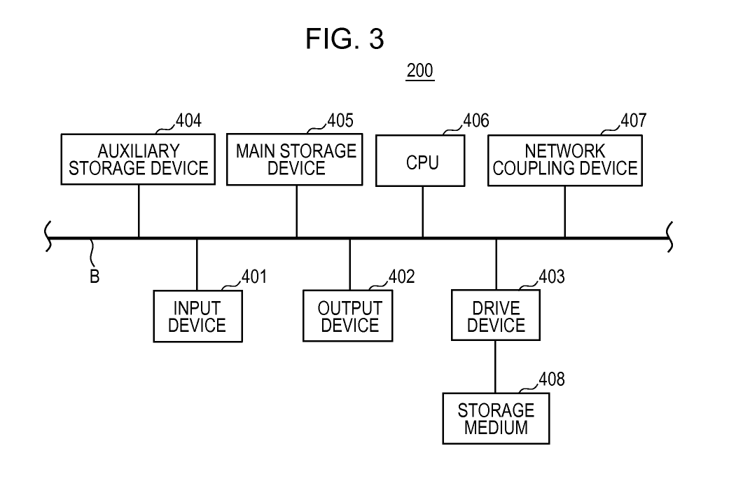

FIG. 3 is a diagram illustrating an example of a hardware configuration of the discussion support server 200. The discussion support server 200 in FIG. 3 includes an input device 401, an output device 402, a drive device 403, an auxiliary storage device 404, a main storage device 405, a central processing unit (CPU) 406, and a network coupling device 407, which are connected to one another via a system bus B.

The input device 401 includes a keyboard operated by a user in charge of the management, or the like, a pointing device such as a mouse, and a voice input device such as a microphone, and accepts input of, for example, instructions from a user or the like to execute a program, various kinds of operation information, and information for starting software or the like.

The output device 402 includes a display that displays various kinds of windows, data, and the like desired to operate a main computer for performing the process according to the present embodiment, and displays the progress or results of the program execution in accordance with a control program included in the CPU 406.

The execution program to be installed in the main computer in the present embodiment is provided by, for example, Universal Serial Bus (USB) memory, a portable storage medium 408 such as compact disc read-only memory (CD-ROM) or a digital versatile disc (DVD), or the like. The storage medium 408 storing a program may be set in the drive device 403, and the execution program included in the storage medium 408 is installed from the storage medium 408 to the auxiliary storage device 404 via the drive device 403 based on a control signal from the CPU 406.

For example, the auxiliary storage device 404 is a storage unit, such as a hard disk drive or a solid state drive (SSD), or the like. Based on the control signal from the CPU 406, the auxiliary storage device 404 may store the execution program according to the present embodiment, a control program provided to the computer, and the like, and performs input and output when desired. Based on the control signal from the CPU 406 or the like, the auxiliary storage device 404 may read desired information from each of the stored information or write desired information.

The main storage device 405 stores the execution program that the auxiliary storage device 404 has read in accordance with the CPU 406, and the like. For example, the main storage device 405 is ROM, random-access memory (RAM), or the like but is not limited hereto. The auxiliary storage device 404 and the main storage device 405 correspond to the above-described storage unit 220 for example.

Based on the control program, such as an operating system, and the execution program stored in the main storage device 405, the CPU 406 may control the operations of the entire computer and implement each operation through various kinds of computing, input and output of data in cooperation with each hardware configuring unit, or the like. Various kinds of information or the like desired in executing the program may be acquired from, for example, the auxiliary storage device 404, and the execution results or the like may be stored in the auxiliary storage device 404.

For example, based on the execution instructions of the program, or the like, which are obtained from the input device 401, the CPU 406 performs operations corresponding to the program on the main storage device 405 by causing the program installed in the auxiliary storage device 404 to be executed.

For example, the CPU 406 executes the discussion support program to perform the above-described operations including the grouping of the students through the grouping unit 211, the login of the students through the login unit 212, the collection of the opinions through the opinion collecting unit 213, and the point calculation through the point calculating unit 214. The contents of the operations of the CPU 406 are not limited hereto. The contents of the operations executed by the CPU 406 may be stored in the auxiliary storage device 404 when desired.

Based on the control signal from the CPU 406, the network coupling device 407 becomes coupled to a communication network, such as the Internet or a LAN, and acquires the execution program, the software, the setting information, and the like from an external device coupled to the communication network. Also, the network coupling device 407 may provide the execution results obtained by executing the program or the execution program itself of the present embodiment to the external device or the like.

While the information terminal 10 may also have the above-described hardware configuration, when the information terminal 10 is, for example, a communication terminal such as a smartphone, the information terminal 10 may include a positioning device using, for example, the function of the Global Positioning System (GPS), an acceleration sensor, an angular velocity sensor, or the like in addition to the above-described configuration. The network coupling device 407 may include a communication unit that enables communication via, for example, Wi-Fi (registered trademark) or Bluetooth (registered trademark). Further, the information terminal 10 may include a conversation unit that enables conversation with a telephone terminal.

The above-described hardware configuration enables the discussion support process according to the present embodiment to be performed. Also, the discussion support process according to the present embodiment may be easily implemented with a general-purpose PC, an information terminal, or the like by installing the execution program (the discussion support program).

[An Example of the Process of the Discussion Support Server 200]

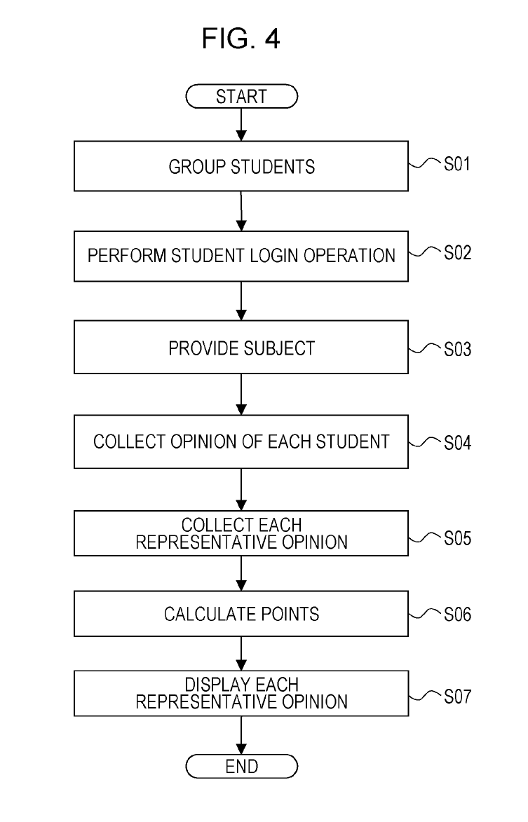

An example of the process of the discussion support server 200 according to the present embodiment is described with reference to a flowchart. FIG. 4 is a flowchart illustrating the example of the process of the discussion support server 200.

In the example of FIG. 4, the grouping unit 211 of the discussion support server 200 acquires information on the students 11 who participate in the discussion, which is included in the student DB 221, and performs grouping (S01). Based on the previous discussion results, the previous point transition of each student before the timing of the grouping, or the like, the grouping may be performed by the grouping unit 211 so that the number of people in each group or the number of groups may have a given value, but is not limited hereto. The information after the grouping is stored in the group DB 222. In the present embodiment, it is preferable that based on group identifying information (a group ID) or the like stored in the group DB 222, the students 11 are provided with a given seating chart and seated in advance in accordance with the seating chart, but the seating arrangement is not limited hereto.

On receiving a login request from the information terminal 10 of the student 11, the login unit 212 of the discussion support server 200 performs login authentication of the student 11 (S02). In operation S02, the login unit 212 refers to the student DB 221 based on the authentication information obtained from the information terminal 10 and input by the student 11, such as a user ID (a student ID), a password, or the like, and performs the authentication in accordance with whether or not the corresponding student information is present. When the authentication fails, a message indicating the failure is provided to the target information terminal 10.

When the authentication succeeds, the opinion collecting unit 213 of the discussion support server 200 extracts information on a subject of the discussion from the subject DB 223, and transmits and provides the extracted subject to the information terminal 10 that has succeeded in the authentication (S03). Next, the opinion collecting unit 213 collects the respective opinions of the students 11 on the provided subject from the information terminals 10 that the students 11 individually possess (S04). The collected individual opinions are stored in the opinion DB 224.

Subsequently, after the discussion has been conducted in each group, the opinion collecting unit 213 collects representative opinions from the information terminals 10 that the respective leaders of the groups use (the leader terminals) (S05). The collected representative opinions are stored in the opinion DB 224.

The point calculating unit 214 of the discussion support server 200 calculates points based on the characteristics of the individual opinions (the opinion types), which are obtained in operation S04, the characteristics of the representative opinions (the opinion types), which are obtained in operation S05, and the like (S06). The point calculation may be updated during class.

The point calculating unit 214 may calculate the points of each student based on, for example, the conditions set for the point condition DB 225 in advance. The calculated points are stored in the point DB 226. The characteristics of the individual opinions (the opinion types) may be acquired from the opinion characteristic DB 224, and the characteristics of the representative opinions may be acquired from the representative opinion characteristic DB 228, but are not limited hereto.

The display unit 215 of the discussion support server 200 causes each representative opinion or the like to be displayed on the display device 300 (S07). In operation S07, the individual opinion of each student may be displayed on the display device 300. Also, in operation S07, the point calculation results obtained in operation S06 may be displayed on the teacher terminal or the like. While the above-described operations are repeatedly performed for every discussion, the student login may be performed only once in the first discussion.

[An Example of a Process of Displaying Each Student's Points Performed by the Display Unit 215]

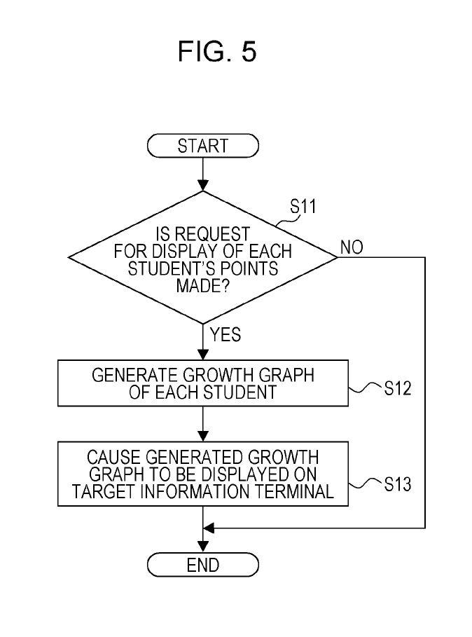

An example of a process of displaying each student's points, which is performed by the display unit 215, is now described with reference to a flowchart. FIG. 5 is the flowchart illustrating the example of the point display process of the display unit 215.

In the example of FIG. 5, the display unit 215 determines whether or not a request for displaying each student's points has been made by the information terminal that the teacher uses (the teacher terminal) 10 or the like (S11). When the request is made (YES in S11), the display unit 215 generates a growth graph or the like of each student based on the point information on each student, which is obtained from the point DB 226 (S12), and causes the generated graph to be displayed on the target information terminal 10 (S13). The target information terminal 10 is the teacher terminal but is not limited hereto and for example, the display device 300 may display the growth graph or the like.

Since the contents of the discussion in the group are thus transmitted to the teacher's information terminal or the like as points, the contents of the discussion, which are invisible, may become clear and the transition of the individual ability (the growth) of each student regarding the discussion may be grasped. An example of the growth graph is described below. While in the above-described example, the growth graph is generated as an example of the point transition illustrated by the display unit 215, the illustration is not limited hereto and the point transition may be illustrated in another way, such as in a table, or the like.

[Screen Examples of the Information Terminal 10 of the Student 11]

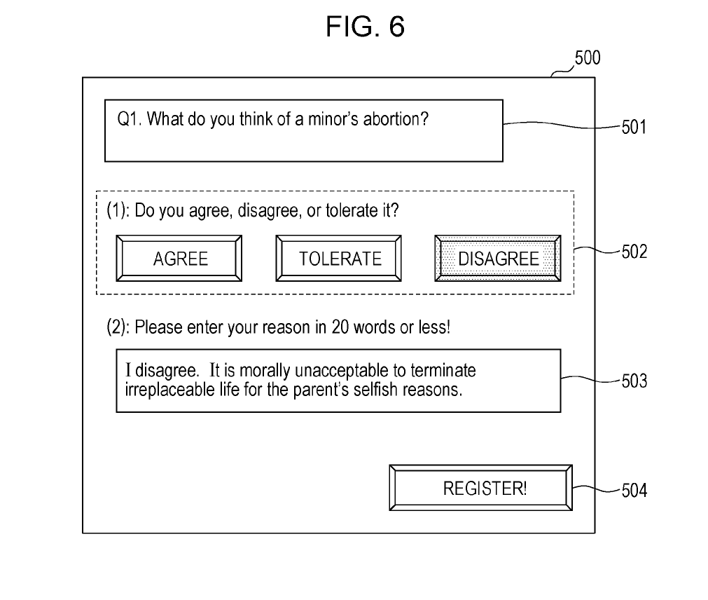

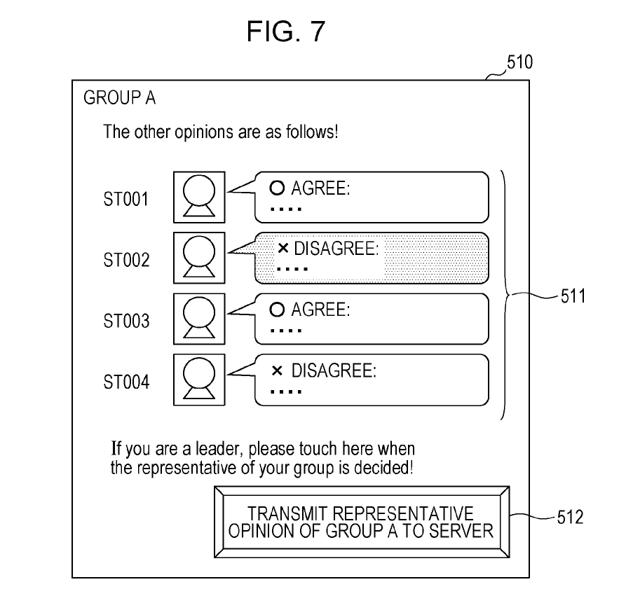

Screen examples of the information terminal 10 of the student 11 are now described with reference to diagrams. FIG. 6 is a diagram illustrating an example of a screen 500 on which a subject is displayed in the information terminal 10. The screen 500 illustrated in FIG. 6 is generated by the display unit 215. FIG. 7 illustrates a screen example of the information terminal 10 of the student who has become the leader of the group.

The screen 500 illustrated in FIG. 6 displays a subject display field 501, a choice field 502 from which each student is caused to choose a category, an opinion input field 503 to which each student is caused to input his or her opinion, and an opinion registration button 504.

When on the screen 500 of the information terminal 10 of the student, a category is chosen from the choice field 502, an opinion is input to the opinion input field 503, and the opinion registration button 504 is operated, the opinion collecting unit 213 of the discussion support server 200 acquires the information. In the example of FIG. 6, the opinion type of “DISAGREE” and the opinion data are acquired. The opinion collecting unit 213 causes the information including the acquired opinion and the like to be registered in the opinion DB 224.

In the example of FIG. 6, the choice field 502 includes buttons for inputting any one of “AGREE”, “TOLERATE”, and “DISAGREE” as an answer to the subject. The “TOLERATE” represents the state in which the person neither agrees nor disagrees.

The registered opinion of each student is shared and displayed by the information terminals 10 that belong to the same group, and is used in the discussion in the group.

FIG. 7 is a diagram illustrating an example of a screen 510 for sharing the opinions on the information terminals 10. The screen 510 illustrated in FIG. 7 is generated by the display unit 215. FIG. 7 illustrates a screen example of the information terminal 10 of the student who has become the leader of the group.

The screen 510 displays opinion fields 511, in which the opinions of the students who belong to the same group are displayed, and a transmission button 512 for transmitting the representative opinion to the discussion support server 200. The transmission button 512 appears only on the information terminal 10 of the leader. Also, on the information terminal 10 of the student who has become the leader of the group, it may be displayed that the student is the leader of the group.

In the example of FIG. 7, the opinion fields 511 indicate the categories of the opinions of four students who belong to group A and the contents of the opinions. In the present embodiment, the discussion is conducted in group A, the representative opinion of the group is chosen based on the contents of the discussion, and the representative opinion is transmitted from the information terminal 10 of the leader to the discussion support server 200. In the example of FIG. 7, the opinion of the student with the student ID “ST002”, which indicates “DISAGREE”, is chosen as the representative opinion.

The opinion collecting unit 213 of the discussion support server 200 acquires the transmitted information, causes the information to be registered in the opinion DB 224, and sets a representative flag for the opinion adopted as the representative opinion.

[An Example of Data Used in the Discussion Support]

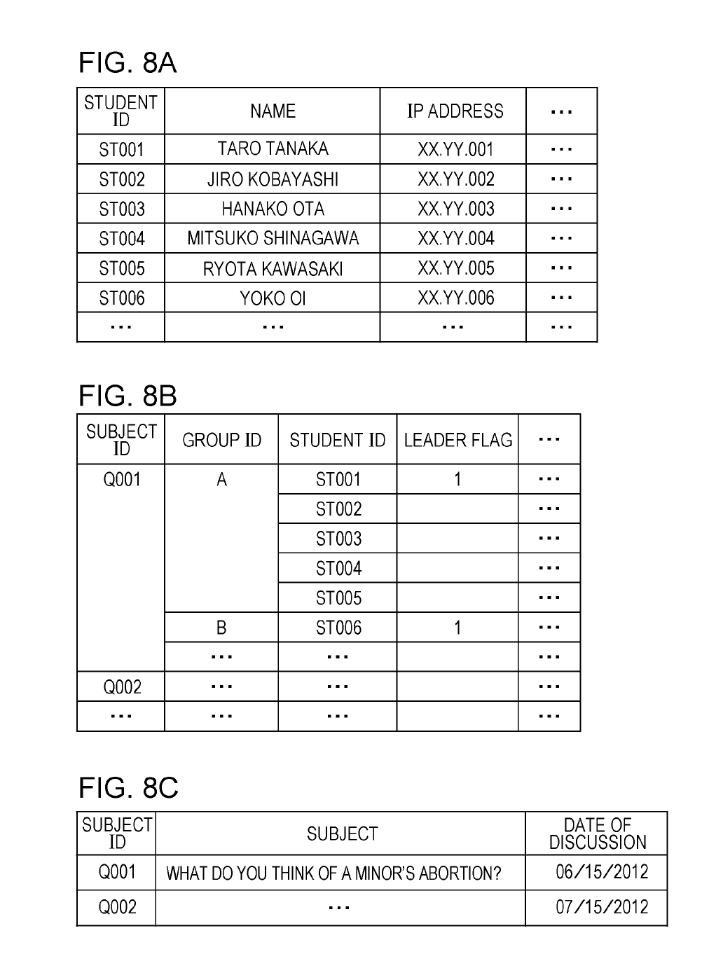

An example of used in the discussion support is now described with reference to tables. FIGS. 8A to 8C are tables illustrating examples of data used in the discussion support. FIG. 8A illustrates the student DB 221, FIG. 8B illustrates the group DB 222, and FIG. 8C illustrates the subject DB 223.

For example, the items of the student DB 221 illustrated in FIG. 8A include “STUDENT ID”, “NAME”, “IP ADDRESS”, and the like but are not limited hereto. The “STUDENT ID” indicates identification information for identifying the students. The “NAME” indicates the name corresponding to the student ID. The “IP ADDRESS” indicates address information for performing the transmission and reception of data between the discussion support server 200 and the information terminal 10, and may also be referred to as identification information for identifying the information terminals 10. That is, the students and the information terminals are managed in the student DB 221 by being related to each other. The IP address is also set for the discussion support server 200 and the information is held on the side of the information terminal 10 and thus, the data may be transmitted and received through a communication network or the like.

The contents of the student DB 221 are not limited hereto, and may also include, for example, information on the name of the student's class, the student's sex, the student's date of birth, and the like. The student DB 221 serves to manage the students who participate in the discussion. The present embodiment may also be provided with a teacher DB similar to the student DB 221, and the like. In this case, “TEACHER IDs” are set instead of the “STUDENT IDs”, and the teachers and the information terminals are managed by being related to each other.

For example, the items of the group DB 222 illustrated in FIG. 8B include “SUBJECT ID”, “GROUP ID”, “STUDENT ID”, and “LEADER FLAG” but are not limited hereto.

The subject ID indicates information for identifying the subjects, which is stored in the subject DB 223 illustrated in FIG. 8C. Since in the discussion support system 100, for example, group members may be changed for every subject, the student IDs of each group are registered for each subject in the example of FIG. 8B. For example, the groups are made for every subject, group A has five persons, and the leader of the group A is “TARO TANAKA” having the student ID “ST001”. The leader may be set in advance by the teacher using the information terminal (the teacher terminal) 10, or may be set randomly based on the point results, the point transition, and the like. Once the leader is set, “1” is set for the “LEADER FLAG” of the student. The leader specifies the representative opinion of the group and transmits the specified representative opinion to the discussion support server 200.

For example, the items of the subject DB 223 illustrated in FIG. 8C include “SUBJECT ID”, “SUBJECT”, and “DATE OF DISCUSSION” but are not limited hereto. In the example of FIG. 8C, the subjects and the dates of the discussions are registered for every subject ID, which indicates the identification information for identifying the subjects. As the “DATE OF DISCUSSION”, the date on which the discussion was conducted or the date on which the discussion will be conducted may be stored.

In the present embodiment, based on the above-described data, a subject is transmitted to each of the grouped students, and points are calculated based on the collected results of the individual opinions and the representative opinions.

The point calculation involves acquiring the opinions of the students in the group discussion and further determining the opinion characteristic of the group to which the students belong. For example, the opinion characteristic of the group indicates “(1) a group with only the same opinions as the student's opinion”, “(2) a half-and-half group with opinions the same as and different from the student's opinion”, “(3) a group in which the number of opinions different from the student's opinion is larger than the number of opinions the same as the student's opinion”, or the like but is not limited hereto. When the representative opinion of the group is transmitted, the points for the student selected as a student of the representative opinion are calculated as, for example, discussion skill growth points or the like.

### Embodiment 1 of the Point Calculation

Embodiment 1 of the point calculation is now described. In Embodiment 1, for example, when the opinion of some student is chosen as the representative opinion of a group, points are calculated based on the corresponding group characteristic. In Embodiment 1, for example, “+5”, “+3”, and “+1” are set as points to be added for the cases of the above-described (3), (2), and (1), respectively. When the opinion of the student is not chosen as the representative opinion, no points denoted by “±0” are added.

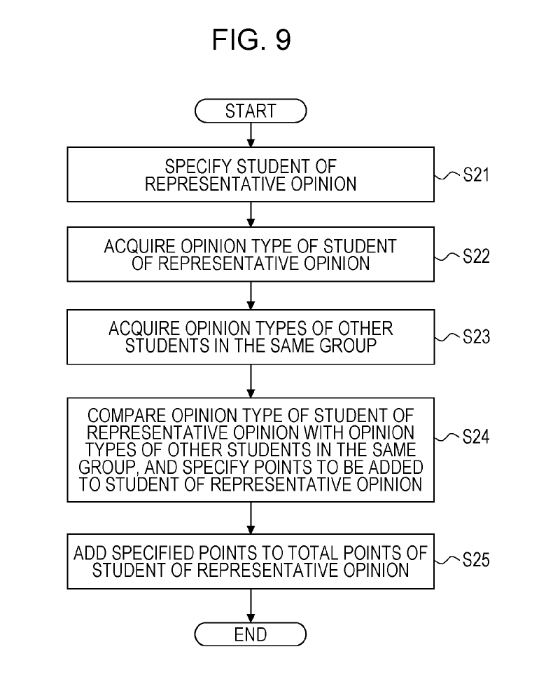

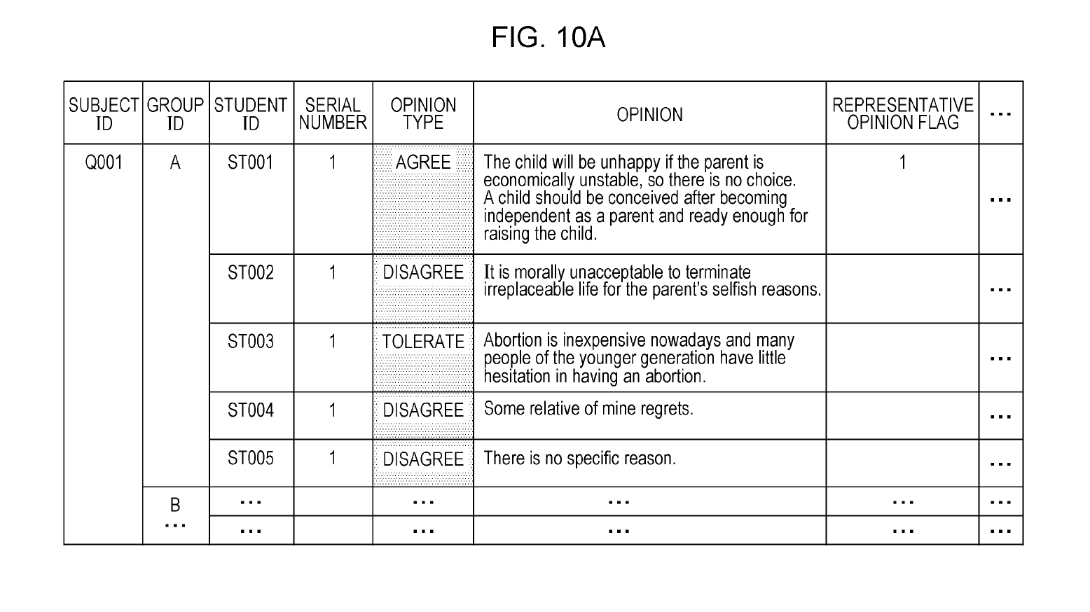

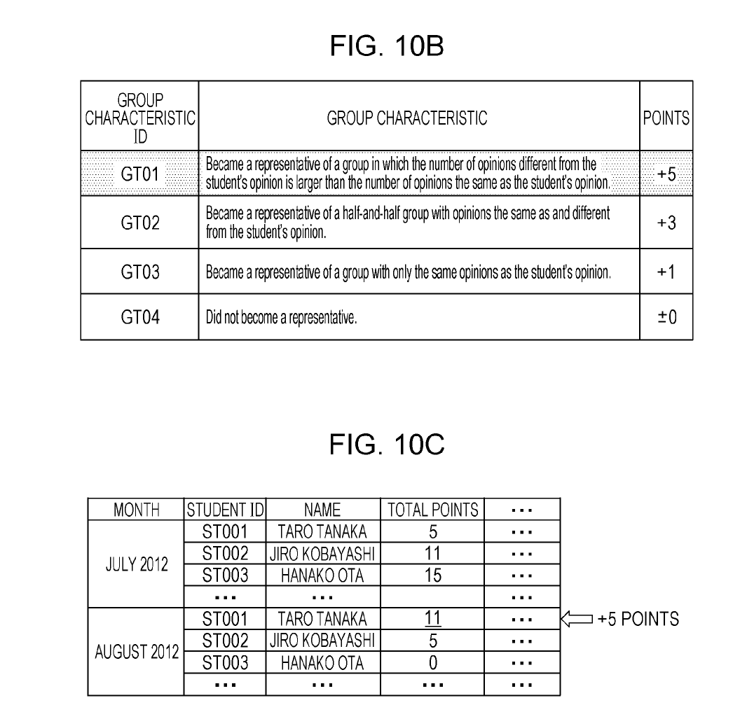

FIG. 9 is a flowchart illustrating an example of a point calculating process according to Embodiment 1. FIGS. 10A to 10C are tables illustrating examples of various kinds of data according to Embodiment 1. FIG. 10A illustrates an example of the opinion DB 224 according to Embodiment 1, FIG. 10B illustrates an example of the point condition DB 225 according to Embodiment 1, and FIG. 10C illustrates an example of the point DB 226 according to Embodiment 1.

In the example of FIG. 9, the point calculating unit 214 specifies a student of the representative opinion (S21). In operation S21, for example, the student for whom “1” is set as the representative opinion flag in the opinion DB 224 illustrated in FIG. 10A is referred to as the student of the representative opinion, but is not limited hereto.

Subsequently, the point calculating unit 214 acquires the opinion type of the student of the representative opinion, which indicates for example, “AGREE”, “TOLERATE”, or “DISAGREE”, from the opinion DB 224 (S22), and further acquires the opinion types of the other students in the same group (S23).

Then, the point calculating unit 214 specifies the points to be added to the student of the representative opinion by comparing the opinion type of the student of the representative opinion with the opinion types of the other students in the same group (S24). In operation S24, the point calculating unit 214 may specify the points by referring to the point condition DB 225 illustrated in FIG. 10B based on, for example, the group characteristic obtained from the respective opinion types of the students in the group. The technique for specifying the points is not limited hereto.

After that, the point calculating unit 214 adds the specified points to the total points of the student of the representative opinion in the point DB 226 (S25).

For example, the items of the opinion DB 224 illustrated in FIG. 10A include “SUBJECT ID”, “GROUP ID”, “STUDENT ID”, “SERIAL NUMBER”, “OPINION TYPE”, “OPINION”, “REPRESENTATIVE OPINION FLAG”, and the like but are not limited hereto. The subject ID corresponds to the subject ID in the above-described subject DB 223 illustrated in FIG. 8C. The group ID corresponds to the group ID in the above-described group DB 222 illustrated in FIG. 8B. The student ID corresponds to the student ID in the above-described student DB 221 illustrated in FIG. 8A. The serial number indicates information for identifying the respective data of the students when, for example, the opinion type and the contents of the opinion are changed through a discussion or the like. As regards the opinion type, the opinion type input to the above-described choice field 502 illustrated in FIG. 6 is stored. As regards the opinion, the information input to the opinion input field 503 illustrated in FIG. 6 is stored. As regards the representative opinion flag, the flag is set for the opinion corresponding to the representative opinion chosen at the time of the transmission from the information terminal 10 of the group leader.

For example, the items of the point condition DB 225 illustrated in FIG. 10B include “GROUP CHARACTERISTIC ID”, “GROUP CHARACTERISTIC”, “POINTS”, and the like but are not limited hereto. The group characteristic ID indicates information for identifying the group characteristic. The group characteristic indicates the contents of the group characteristic for the group characteristic ID. The points indicate the points set so as to correspond to the group characteristic. The points are not limited hereto.

For example, the items of the point DB 226 illustrated in FIG. 10C include “MONTH”, “STUDENT ID”, “NAME”, “TOTAL POINTS”, and the like but are not limited hereto. For example, FIG. 10C illustrates an example in which the points of each student are calculated and output for each month, but the calculation and output of the points are not limited hereto and may be performed on a daily or weekly basis.

In Embodiment 1, as illustrated in FIG. 10A, the opinion of the student ID “ST001”, which indicates “AGREE”, has become the representative opinion of group A while many opinions, which amount to a half or more of the group, indicate “DISAGREE”. That is, since the student of the student ID “ST001” has become a representative of the group in which the number of opinions different from the student's opinion is larger than the number of opinions the same as the student's opinion, +5 points are added to the student ID “ST001” by referring to the point condition DB 225 illustrated in FIG. 10B. If Embodiment 1 is implemented in August 2012, according to the example of FIG. 10C, five points are added to the previous total points (for example, six points) of the student with the student ID “ST001” (“TARO TANAKA”), which have been obtained immediately before the point addition, and the points of the student with the student ID “ST001” for August 2012 amount to 11 points.

The “TOTAL POINTS” are managed on a monthly basis in Embodiment 1 but are not limited hereto and may be managed on a daily, weekly, or lesson basis, or the like, and the management may be performed by calculating the average points of each student for every month. Further, the point increase rate of each student, the ranking of the points, and the like may be managed in Embodiment 1.

### Embodiment 2 for the Point Calculation

The point calculation according to Embodiment 2 is described. For example, even when the opinion characteristic of the group is in the state of the above-described “(1) group with only the same opinions as the student's opinion”, students with opinions that are in a minority of the whole class may happen to be gathered in the group. In this case, since the gathered students are particular, it is difficult to be chosen as the student of the representative opinion. For example, even when the opinion characteristic of the group is in the state of the above-described “(3) group in which the number of opinions different from the student's opinion is larger than the number of opinions the same as the student's opinion”, the opinion of the student may be in a majority of the whole class. For example, since the student's opinion is a majority opinion, it may be easy to persuade the other students.

According to Embodiment 2, in the above-described cases, the opinion characteristics of the whole class are held and the points are adjusted by being increased or decreased while taking the opinion characteristics of the whole class into account. For example, the points for the former case are adjusted from “+1” to “+3” and the points for the latter case are adjusted from “+5” to “+3”. When the opinion of the student concerned is chosen as the representative opinion, the points are calculated based on the characteristic of the group of the above-described student.

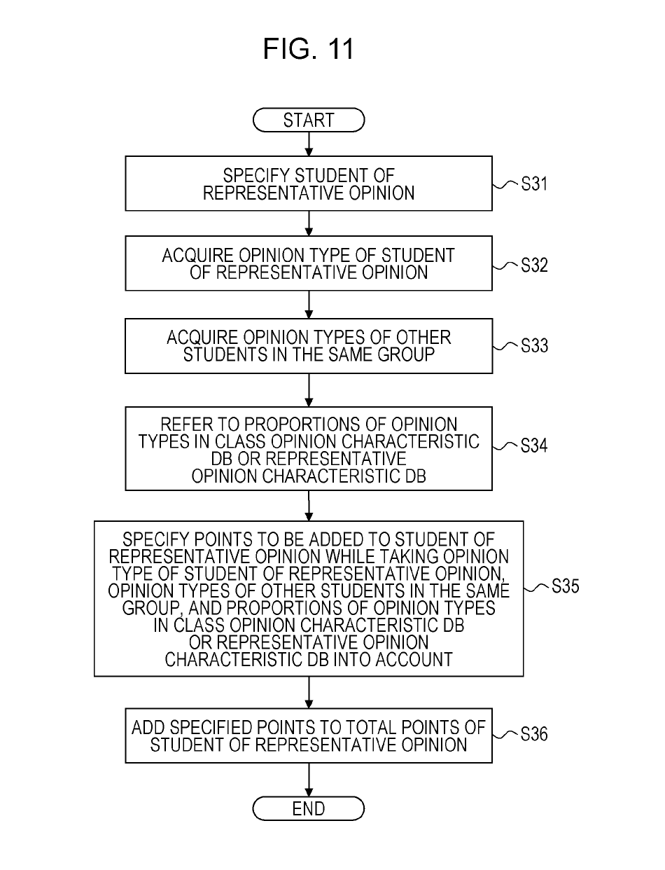

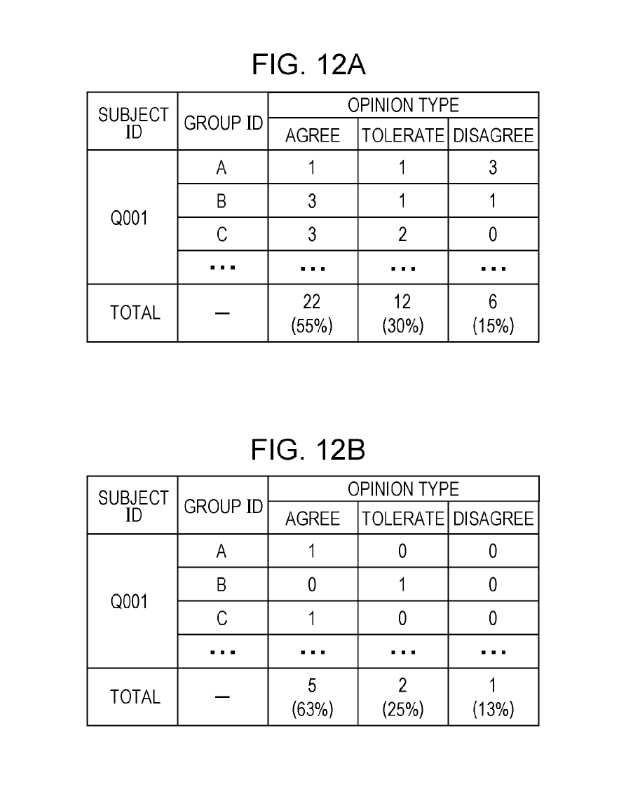

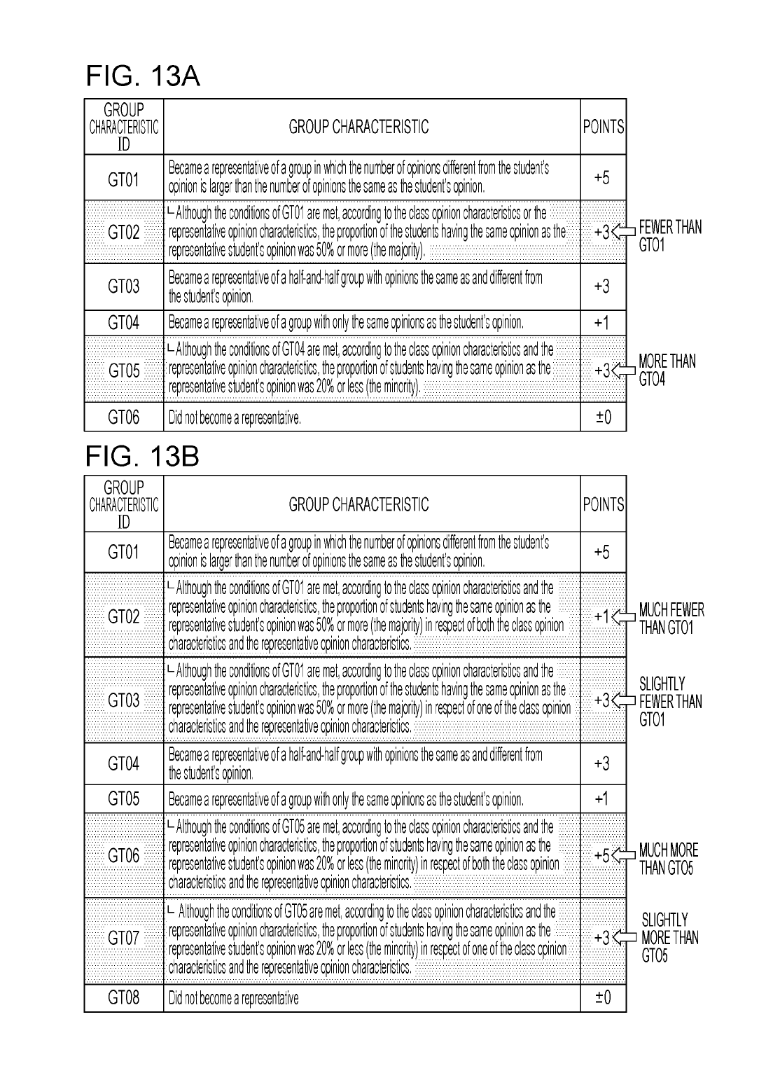

FIG. 11 is a flowchart illustrating an example of the point calculating process according to Embodiment 2. FIGS. 12A and 12B are tables illustrating examples of various kinds of opinion characteristic DBs. FIG. 12A illustrates an example of the class opinion characteristic DB 227 and FIG. 12B illustrates an example of the representative opinion characteristic DB 228. FIGS. 13A and 13B are tables illustrating examples of the point condition DB 226 according to Embodiment 2. FIGS. 13A and 13B indicate point conditions different from each other.

In the example of FIG. 11, similar to Embodiment 1 described above, the point calculating unit 214 specifies a student of the representative opinion, who is for example, the student with the representative opinion flag that indicates “1” in the opinion DB 224 illustrated in FIG. 10A (S31). Also, the point calculating unit 214 acquires the opinion type of the student of the representative opinion (S32) and acquires the opinion types of the other students in the same group (S33).

Subsequently, the point calculating unit 214 refers to the proportions of the opinion types in the class opinion characteristic DB 227 illustrated in FIG. 12A or the representative opinion characteristic DB 228 illustrated in FIG. 12B (S34). Also, the point calculating unit 214 specifies points to be added to the student of the representative opinion by taking the opinion type of the student of the representative opinion, the opinion types of the other students in the same group, and the proportions of the opinion types in the class opinion characteristic DB 227 or the representative opinion characteristic DB 228 into account (S35). After that, the point calculating unit 214 adds the specified points to the total points of the student of the representative opinion in the above-described point DB 226 illustrated in FIG. 10C (S36).

In the example of FIG. 11, the point calculation is performed by acquiring the proportions of the opinion types in the class opinion characteristic DB 227 or the representative opinion characteristic DB 228, but is not limited hereto and may be performed by, for example, acquiring the proportions of the opinion types in both the class opinion characteristic DB 227 and the representative opinion characteristic DB 228 and relating the points to be calculated to the acquired proportions.

For example, the items of the class opinion characteristic DB 227 illustrated in FIG. 12A and the representative opinion characteristic DB 228 illustrated in FIG. 12B include “SUBJECT ID”, “GROUP ID”, and “OPINION TYPE”(“AGREE”, “TOLERATE”, or “DISAGREE”) but are not limited hereto. Each of the class opinion characteristic DB 227 and the representative opinion characteristic DB 228 stores the total and the proportions of the opinion types. The highest number of opinions and the opinion type of the highest proportion decide the opinion characteristic of the group.

In the example of FIG. 12A, the number of students in each group is counted for every opinion type. For example, group A illustrated in FIG. 12A happens to have only one opinion indicating the opinion type “AGREE”, which is a majority opinion of the whole class.

In contrast, in the example of FIG. 12B, since the representative opinions are indicated, one of the opinion types is set in each group. Thus, as illustrated in FIGS. 12A and 12B, the characteristics or the total values (the proportions) of the opinion types may also be different in the class opinion characteristic DB 227 and the representative opinion characteristic DB 228.

The point DB 226 illustrated in FIG. 13A is a point DB that takes the results of the class opinion characteristic DB 227 into account. In the example of FIG. 13A, the point adjustment is performed on the group characteristic IDs GT02 and GT05.

Specifically, when the group characteristic ID is GT02, the conditions of GT01 are met but according to the class opinion characteristics or the representative opinion characteristics, the students having the same opinion as the representative student's opinion are in the majority and the representative opinion may have been chosen without the representative student having made many efforts. Thus, when the group characteristic ID corresponds to the conditions of GT02, the points to be added are adjusted to be fewer than the points for GT01, that is, for example, from +5 to +3.

When the group characteristic ID is GT05, the conditions of GT04 are met but according to the class opinion characteristics or the representative opinion characteristics, the students having the same opinion as the representative student's opinion are in the minority and the representative opinion may have been chosen because of the representative student having made considerable efforts. Thus, when the group characteristic ID corresponds to the conditions of GT05, the points to be added are adjusted to be more than the points for GT04, that is, for example, from +1 to +3. The kinds of the group characteristic or the numbers of points are not limited hereto.

The point DB 226 illustrated in FIG. 13B is a point DB where the results of the representative opinion characteristic DB 228 are taken into account. In the example of FIG. 13B, the point adjustment is performed for the group characteristic IDs GT02, GT03, GT06, and GT07.

Specifically, when the group characteristic ID is GT02, the conditions of GT01 are met but according to the class opinion characteristics and the representative opinion characteristics, the students having the same opinion as the representative student's opinion are in the majority in respect of both the class opinion characteristics and the representative opinion characteristics, and the representative opinion may have been chosen without the representative student having made almost any efforts. Thus, when the group characteristic ID corresponds to the conditions of GT02, the points to be added are adjusted to be much fewer than the points for GT01, that is, for example, from +5 to +1.

When the group characteristic ID is GT03, the conditions of GT01 are met but according to the class opinion characteristics and the representative opinion characteristics, the students having the same opinion as the representative student's opinion are in the majority in respect of one of the class opinion characteristics and the representative opinion characteristics, and the representative opinion may have been chosen without the representative student having made many efforts. Thus, when the group characteristic ID corresponds to the conditions of GT03, the points to be added are adjusted to be slightly fewer than the points for GT01, that is, for example, from +5 to +3.

When the group characteristic ID is GT06, the conditions of GT05 are met but according to the class opinion characteristics and the representative opinion characteristics, the students having the same opinion as the representative student's opinion are in the minority in respect of both the class opinion characteristics and the representative opinion characteristics, and the representative opinion may have been chosen because of the representative student having made considerable efforts. Thus, when the group characteristic ID corresponds to the conditions of GT06, the points to be added are adjusted to be much more than the points for GT05, that is, for example, from +1 to +5.

When the group characteristic ID is GT07, the conditions of GT05 are met but according to the class opinion characteristics and the representative opinion characteristics, the students having the same opinion as the representative student's opinion are in the minority in respect of one of the class opinion characteristics and the representative opinion characteristics, and the representative opinion may have been chosen because of the representative student having made a few efforts. Thus, when the group characteristic ID corresponds to the conditions of GT07, the points to be added are adjusted to be slightly more than the points for GT05, that is, for example, from +1 to +3.

According to Embodiment 2, the above-described point adjustment enables the discussion skills of each student to be evaluated more appropriately.

### Embodiment 3 of the Point Calculation

Embodiment 3 of the point calculation is described. In Embodiment 3, the “POINT INCREASE RATE” of the ability points of each student is held and when the opinion of the student concerned is chosen as the representative opinion while there are more students in the group than a half of the group, who are higher in “POINT INCREASE RATE” than the student of the representative opinion, bonus points, which are for example, +2 points, are further added.

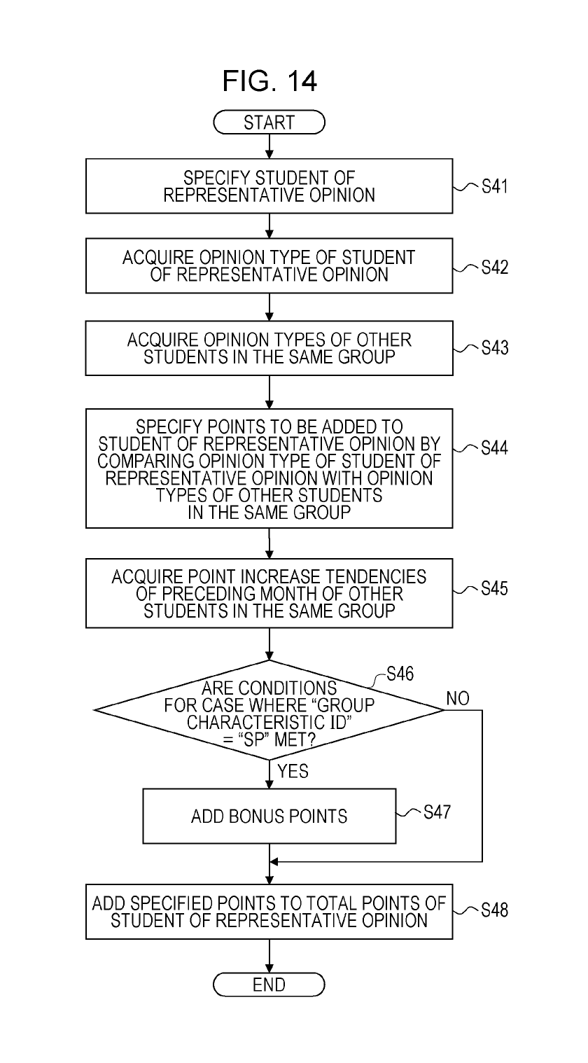

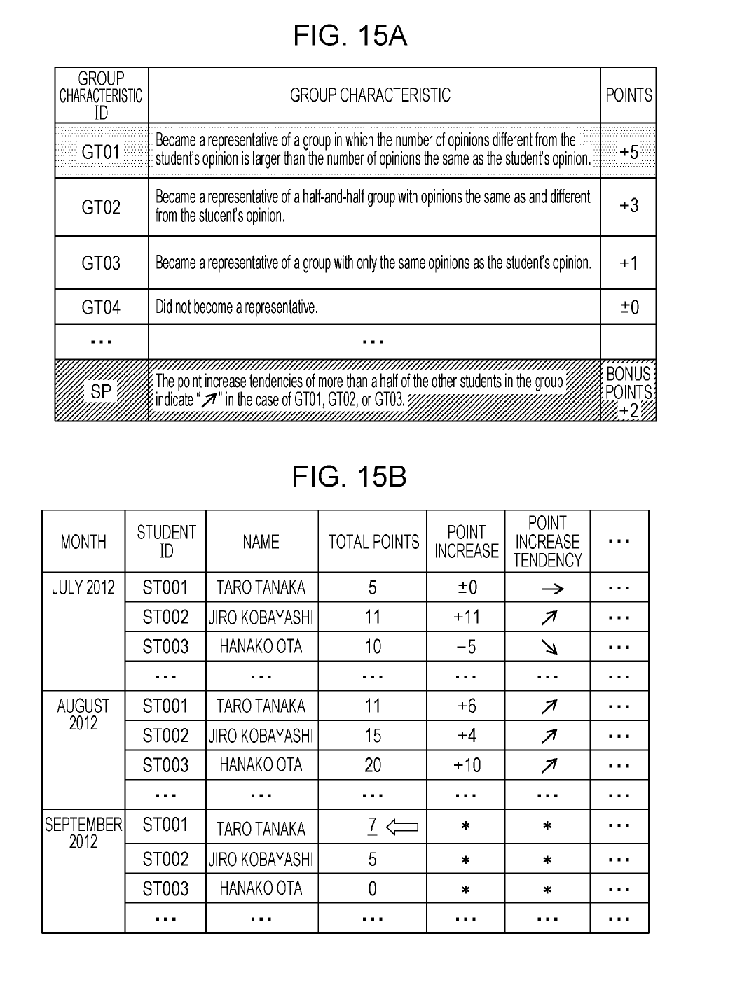

FIG. 14 is a flowchart illustrating an example of the point calculating process according to Embodiment 3. FIGS. 15A and 15B are tables that illustrate examples of various kinds of data according to Embodiment 3. FIG. 15A illustrates an example of the point condition DB 225 according to Embodiment 3 and FIG. 15B illustrates an example of the point DB 226 according to Embodiment 3.

In the example of FIG. 14, similar to Embodiment 1 described above, the point calculating unit 214 specifies a student of the representative opinion, who is for example, the student with the representative opinion flag that indicates “1” in the above-described opinion DB 224 illustrated in FIG. 10A (S41). Subsequently, the point calculating unit 214 acquires the opinion type of the student of the representative opinion (S42) and acquires the opinion types of the other students in the same group (S43).

After that, the point calculating unit 214 specifies points to be added to the student of the representative opinion by comparing the opinion type of the student of the representative opinion with the opinion types of the other students in the same group (S44). Then, the point calculating unit 214 acquires the point increase tendencies of the other students in the same group, which are obtained in the preceding month (S45).

After that, for example, the point calculating unit 214 determines whether or not the case corresponds to the “GROUP CHARACTERISTIC ID” of “SP” in the point condition DB 225 illustrated in FIG. 15A (S46). Since in Embodiment 3, the group characteristic ID to which the bonus points are added based on the increase tendencies of the other students in the group is set as “SP”, it is determined whether or not the case corresponds to the “GROUP CHARACTERISTIC ID” of “SP”. However, the determination is not limited hereto and when for example, a plurality of group characteristic IDs are set to add the bonus points under other conditions or the like, it is determined whether or not the case corresponds to any one of the group characteristics.

When the conditions for the case of the group characteristic ID “SP” are met (YES in S46), the point calculating unit 214 adds the bonus points to the points specified in operation S44 (S47). Also, when the conditions for the case of the group characteristic ID “SP” are not met in operation S46 (NO in S46), or after operation S47, the point calculating unit 214 adds the specified points to the total points of the student of the representative opinion (S48).

In the example of FIG. 15A, the group characteristic ID “SP” is set and as the conditions of the group characteristic ID “SP”, the case in which the point increase tendencies of more than a half of the other students in the group indicate “an upward arrow”, which denotes a rise, is set for the group characteristic ID GT01, GT02, or GT03. In this case, since the opinion of the student is chosen as the representative opinion from among the opinions of many students whose points have been increasing, the student of the representative opinion may have made considerable efforts in the discussion. Thus, when the conditions of “SP” are met, +2 points are added as the bonus points.

For example, the items of the point DB 226 illustrated in FIG. 15B include “MONTH”, “STUDENT ID”, “NAME”, “TOTAL POINTS”, “POINT INCREASE”, “POINT INCREASE TENDENCY”, and the like but are not limited hereto. Compared with the point DB 226 in FIG. 10C described above, the items of the “POINT INCREASE” and the “POINT INCREASE TENDENCY” are added in the point DB 226 illustrated in FIG. 15B. The “POINT INCREASE” indicates the increase in points (differential values) in comparison with the preceding month, and the “POINT INCREASE TENDENCY” indicates the tendency corresponding to the point increase. In the example of FIG. 15B, the point increase tendency is expressed by the inclination of the arrow but is not limited hereto.

According to Embodiment 3, in September 2012, “TARO TANAKA” of the student ID “ST001” has become the representative of the group in which the number of opinions different from the student's opinion is larger than the number of opinions the same as the student's opinion and acquires +5 points. Further, since the point increase tendencies of more than a half of the other students in the group indicate “upward”, +2 points are added, and as illustrated in FIG. 15B, a total of seven points are stored when the value of the points immediately before the point addition is zero.

For example, as to the point increase tendency illustrated in FIG. 15B, the “TOTAL POINTS” are calculated every month and based on the “TOTAL POINTS” of the preceding month and the month before the preceding month, the “POINT INCREASE” and the “POINT INCREASE TENDENCY” are set every time the month changes, but the calculation and the setting are not limited hereto.

According to Embodiment 3, the discussion ability of each individual may be appropriately evaluated by adjusting the point conditions as described above, depending on the circumstances of the discussion and the opinion characteristics in the group. If desired, Embodiments 1 to 3 for the point calculation described above may be performed by being combined.

[Examples of the Calculation Results Generated by the Display Unit 215]

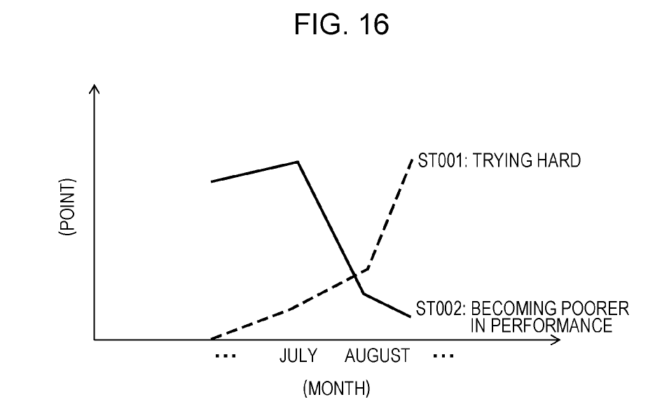

Examples of the calculation results generated by the display unit 215 are now described with reference to a graph. FIG. 16 illustrates an example of a growth graph generated by the display unit 215. For example, FIG. 16 is a graph generated by the above-described process of displaying the points of each student, which is illustrated in FIG. 5.

The display unit 215 generates a screen that displays the fluctuations of the number of points as a graph of the growth transition based on, for example, the point acquisition history of each student, which is stored in the above-described point DB 226.

The example of FIG. 16 indicates the transition of the points acquired by the students with the student IDs “ST001” and “ST002”. The display unit 215 causes the transition to be displayed on the screen of the information terminal 10 that the teacher uses. The teacher refers to the screen of his or her own information terminal 10, which is illustrated in FIG. 16, and may easily evaluate that the student with the student ID “ST001” is trying hard and the student with the student ID “ST002” is becoming poor in performance. Thus, the adjustment may be performed, which includes causing the student with the student ID “ST001” to become a leader or avoiding the student with the student ID “ST002” becoming a leader. The graph of FIG. 16 may be displayed by the display device 300.

The calculation results generated by the display unit 215 are not limited hereto and may be displayed by, for example, illustrating a table or the like, and may be displayed in units of students' lesson subjects, days of the week, or the like. Accordingly, the abilities may be evaluated based on the personalities or weak areas of individuals, the preferable time periods for concentration, or the like. Additionally, the point evaluation may be observed in various respects.

As described above, according to the present embodiments, the discussion skills of the individuals may be appropriately evaluated. For example, the teacher or the like may appropriately grasp and evaluate the growth transition of the discussion skills of each student by evaluating the discussion skills or the like through the points based on what opinion characteristic of the group has decided the representative opinion, and the like. Thus, the discussion skills that are normally invisible may be grasped by being made visible as the points based on circumstances, such as the characteristic of the other people who participate in a discussion conducted in a group, the characteristic of each class or group, or the like.

The embodiments are described above by taking the discussion support for the discussions among students in a school as an example, but are not limited hereto and may be widely applied to other communities that conduct discussions, such as a gathering of a circle, an event, or a seminar, meetings in companies, or the like. When the embodiments are applied to a meeting in a company, the class, the teacher, and the students may be replaced with a department, a superior, and subordinates, respectively, but the embodiments are not limited hereto.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a discussion support program that causes a computer to execute a process, the process comprising:
collecting opinion data obtained from each information terminal and a group characteristic corresponding to the opinion data collected in each group including a plurality of information terminals set in advance; and
calculating a point of a participant related to the information terminal based on representative opinion data chosen from the opinion data collected in each group and the group characteristic corresponding to the group to which the information terminal having transmitted the representative opinion data belongs.

2. The storage medium storing the discussion support program according to claim 1, wherein the calculating the point includes changing an amount of points to be added based on a relation between an opinion type of a participant of a representative opinion and an opinion type of another participant in the group.

3. The storage medium storing the discussion support program according to claim 1, wherein the point is adjusted from the calculated point based on an opinion characteristic of each of the groups or opinion characteristics of all the groups.

4. The storage medium storing the discussion support program according to claim 1, wherein a point increase rate of the another participant in the group is acquired, and a point is further added to the calculated point based on the acquired point increase rate.

5. The storage medium storing the discussion support program according to claim 1, wherein transition of the calculated point of each participant is illustrated and displayed on a screen of a given information terminal.

6. The storage medium storing the discussion support program according to claim 1, wherein a participant who transmits group representative opinion data is decided in the group based on the transition of the point of each participant.

7. A discussion support method of causing an information processing apparatus to execute a process, the process comprising:
collecting opinion data obtained from each information terminal and a group characteristic corresponding to the opinion data collected in each group including a plurality of information terminals set in advance; and
calculating a point of a participant related to the information terminal based on representative opinion data chosen from the opinion data collected in each group and the group characteristic corresponding to the group to which the information terminal having transmitted the representative opinion data belongs.

8. The discussion support method of causing an information processing apparatus to execute a process according to claim 7, wherein the calculating the point includes changing an amount of points to be added based on a relation between an opinion type of a participant of a representative opinion and an opinion type of another participant in the group.

9. The discussion support method of causing an information processing apparatus to execute a process according to claim 7, wherein the point is adjusted from the calculated point based on an opinion characteristic of each of the groups or opinion characteristics of all the groups.

10. The discussion support method of causing an information processing apparatus to execute a process according to claim 7, wherein a point increase rate of the another participant in the group is acquired, and a point is further added to the calculated point based on the acquired point increase rate.

11. The discussion support method of causing an information processing apparatus to execute a process according to claim 7, wherein transition of the calculated point of each participant is illustrated and displayed on a screen of a given information terminal.

12. The discussion support method of causing an information processing apparatus to execute a process according to claim 7, wherein a participant who transmits group representative opinion data is decided in the group based on the transition of the point of each participant.

13. An information processing apparatus comprising:
an opinion collecting unit that collects opinion data obtained from each information terminal and a group characteristic corresponding to the opinion data collected in each group including a plurality of information terminals set in advance; and
a point calculating unit that calculates a point of a participant related to the information terminal based on representative opinion data chosen from the opinion data collected in each group and the group characteristic corresponding to the group to which the information terminal having transmitted the representative opinion data belongs.
